(19) United States
(12) Patent Application Publication
(10) Pub. No.: US 2024/0215537 A1
(43) Pub. Date: Jul. 4, 2024

(54) METHOD, APPARATUS, AND SYSTEM FOR PET CLEANING AND DRYING AT PET DOOR

(71) Applicant: Abby Milam, Fayetteville, AR (US)

(72) Inventor: Abby Milam, Fayetteville, AR (US)

(21) Appl. No.: 18/487,039

(22) Filed: Oct. 13, 2023

Related U.S. Application Data
(60) Provisional application No. 63/379,467, filed on Oct. 14, 2022.

(51) Int. Cl. A01K 13/00; E06B 7/32

(52) U.S. Cl. CPC A01K 13/001; E06B 7/32

(57) ABSTRACT

A system for cleaning and drying the paws of a dog proximate a dog door may include an exterior cleaning unit providing a cleaning zone structure including a cleaning zone runway which may be inclined, a cleaning fluid tray beneath the cleaning zone runway, a primary paw receiving structure which may deflect downward under load, and a secondary paw contacting structure submerged in cleaning fluid beneath the runway. The secondary paw contacting structure may include a recessed mat supported on a tray and submerged in cleaning fluid. A releasable open tunnel subsystem confines the dog to traverse the cleaning zone runway. The system may include an interior cleaning unit providing a drying zone structure including a drying zone runway. A drying zone collection tray may be included beneath the drying zone runway to collect extraneous material. Drying zone structure may be formed of moisture-absorbing material.

### CROSS-REFERENCE TO RELATED APPLICATIONS

This application is related and claims priority to U.S. Provisional Application No. 63/379,467 filed Oct. 14, 2022 titled METHOD, APPARATUS, AND SYSTEM FOR A PET DOOR ATTACHMENT, which is incorporated by reference in entirety.

### FIELD OF THE INVENTION

The present disclosure relates to method, apparatus, and systems for pet doors. Particularly, the disclosure relates to devices to clean the pet's feet before entering the house through a pet door.

### BACKGROUND OF THE INVENTION

Pet doors (singular being “pet door” or “dog door”) are useful installations into the homes of pet owners to allow the pet (“canine” or “dog”) autonomy in moving from inside the pet owner's residence or home, to outside the home. It will be understood that disclosed subject matter may find application in combination with a pet door for use by any kind of pet that may utilize a pet door, although embodiments are described herein in relation specifically to dogs and dog doors. The most common embodiment features a four-sided window-like structure covered by a flap of flexible material that can flap inwards or outwards in response to the pet's movement. The flap can be opened in either direction by the dog and closes to mate back with the border through gravity acting on the weight of the flap. Some dog doors have magnetic snaps on the bottom to ensure the flap returns to mate with the door attachment. Dog doors can be installed in holes cut in exterior doors, exterior walls, or garage doors. They can also be fitted into sliding patio doors or storm doors for a less permanent installation. There are also versions that can be installed in double hung windows. Dog doors range in size from small to extra-large to match the size of the canine using the flap.

The installation of a dog door is often considered against a few commonly cited downsides. These include security concerns, decreases in energy efficiency, and loss of control of what the dog can bring in the house. Many solutions have been explored to address these downsides such as security locks, smart entrance solutions, weather-stripping. One area that has not been previously addressed is facilitating what the dog does and does not bring inside from the outside. One of the downsides to installing a dog door is that with autonomy to move between outside and inside, the dog gains unchecked ability to track in dirt and mud from the outdoors into the house. Unlike security concerns, this disadvantage can cause issues on a daily basis as dogs go in and out many times a day. With these movements, the dog is likely to track in dirt and mud. It is a common practice of many dog owners to lock the dog door in rainy weather. However, this practice requires constant monitoring of weather conditions in addition to going against the purpose of the dog door, that of autonomy. Additionally, even in the best weather situations, dogs can bring in dirt and leaves.

This disclosure describes a method, apparatus and system for cleaning a dog at a dog door. Disclosed subject matter may prevent the tracking in of unwanted material on the pet entering the residence through the dog door. A method for cleaning a dog at a dog door may include positioning pet cleaning apparatus proximate the dog door on an exterior side; attaching pet drying apparatus proximate the dog door on an interior side; confining the dog approaching the dog door to enter the residence on the exterior side to contact a first pet cleaning fluid applicator on the exterior side proximate the exterior side of the dog door portal; releasing pet cleaning fluid from the pet cleaning fluid applicator to become applied to paw areas of the dog; confining the dog to enter the residence by transiting through the dog door portal from the exterior side to the interior side; and confining the dog leaving the dog door portal to enter the residence on the interior side to contact a pet drying structure on the interior side proximate the interior side of the dog door portal for fluid to be removed from the paw areas of the dog. Such method may ensure that the dog utilizes the apparatus by confining the dog when entering the residence through the dog door to transit both the pet cleaning zone including the pet cleaning fluid applicator to apply the pet cleaning fluid to the paw areas, and also the pet drying zone including the pet drying structure to remove fluid and particulates from the paw areas. Subject matter includes a system for cleaning and drying the paw areas of a dog at a pet door, as further described in the Detailed Description and the drawings. Subject matter also includes apparatus for cleaning and drying the paw areas of a dog at a pet door, as further described in the Detailed Description and the drawings.

### BRIEF SUMMARY OF THE INVENTION

Apparatus, systems, and methods for cleaning a dog at a dog door may clean and dry the canine's feet before entrance into the house. Such apparatus may include a cleaning application subsystem on the exterior side that confines the dog to transit a cleaning zone wherein the dog is directed in walking across the cleaning zone for the paw areas to contact cleaning fluid application structure to release or provide pet cleaning fluid on the paw areas before the dog passes into the residence through the dog door portal proximate the cleaning zone. In an embodiment, the cleaning zone, cleaning fluid application subsystem, and drying fluid application structure may include a cleaning mat on the exterior side that may provide, release, and wet the paw areas when the cleaning zone is traversed by the dog in order to arrive at and pass through the dog door portal to enter the residence. Such apparatus may include a drying subsystem on the interior side that confines the dog to transit a drying zone wherein the dog is directed in walking across the drying zone for the paw areas to contact drying structure to remove pet cleaning fluid and particulates from the paw areas before the dog exits the drying zone into the general area of the residence after entering the drying zone proximate the dog door portal. In an embodiment, the drying zone, drying subsystem, and drying structure may include a drying mat that may receive, contact, and dry the paw areas after the cleaning zone and dog door portal are traversed. Exterior apparatus may include an exterior pair of spaced parallel tunnel walls extending transverse to the exterior surface of the main door, which are attached, fixed or mounted to the exterior surface of the main door proximate the dog door to direct and confine the dog to pass through the cleaning zone by walking across and traversing the cleaning mat in order to reach and transit the dog door portal to gain entrance into the house through the dog door portal. Interior apparatus may include an interior pair of spaced parallel tunnel walls extending transverse to the interior surface of the main door, which are attached, fixed or mounted to the interior surface of the main door proximate the dog door to direct and confine the dog to pass through the drying zone by walking across and traversing the drying mat after transiting the dog door portal to enter the general area of the house from the interior apparatus.

Such apparatus may be attached to a surface of a main door, a commercially available dog door, or both. In an embodiment, apparatus may be located proximate the dog door portal and attached to the main door proximate the dog door. The mechanisms of attachment may include permanent or removeable fasteners such as nails, screws, magnets, or slides. Embodiments of apparatus may have different sizes suitable for use with dog doors having corresponding different sizes.

When such apparatus is in use, the sides may snap up to create an open tunnel on the exterior side to guide the paw areas across the cleaning zone. The tunnel may extend on the indoor side of the dog door to guide the paw areas across the drying zone. In an embodiment, the tunnel may attach to the dog door or main door hooks or other suitable fasteners to keep the tunnel in place.

The cleaning zone, cleaning subsystem, and cleaning fluid applicator may be located on the exterior side of the main door and proximate the exterior side of the dog door, outside the building. The cleaning structure may include a non-slip mat with raised nubs. The cleaning fluid applicator may include a cleaning fluid reservoir and applicator elements in contact with cleaning fluid and paw areas of the dog. In an embodiment, a soap solution may be applied to the cleaning mat to assist in cleaning. The drying zone, drying subsystem, and drying structure may be located on the interior side of the main door proximate the interior side of the dog door, inside the home. In an embodiment, the drying structure may include a chenille rubber memory foam pad, a pad or mat including another material suitable to receive and remove fluid and particulates to dry the paw areas of the dog when walking across the drying zone. Fasteners, such as suction cups, may hold or fix the cleaning pad, drying pad, or both, in place.

In an embodiment, the parallel tunnel sides, cleaning structure, drying structure, and fasteners may include quick connect or disconnect fasteners for the apparatus to be portable to be relocated between locations. In an embodiment, the parallel tunnel sides, cleaning structure, and/or drying structure may include a folding mechanism or accordion mechanism for easy removal and compact storage when not in use.

### BRIEF DESCRIPTION OF THE DRAWINGS

Novel features characteristic of the disclosed subject matter will be set forth in claims, below. The disclosed subject matter, as well as modes of use, further objectives, and advantages thereof, will best be understood by reference to the following detailed description of illustrative embodiments when read in conjunction with the accompanying drawings, which are not drawn to scale except where specifically indicated, and wherein:

FIG. 1 is a simplified partial perspective view of a system for cleaning and drying paw areas of a dog at a pet door, in an exemplary embodiment;

FIG. 2 is an enlarged partial perspective view of the system shown generally in FIG. 1;

FIG. 3 is an exploded partial perspective view of the system shown generally in FIG. 1;

FIG. 4 is an elevated partial perspective view of the system taken generally along 4-4 in FIG. 1, showing a drying zone;

FIG. 5 is an elevated partial perspective view of the system taken generally along 5-5 in FIG. 1 showing a cleaning zone;

FIG. 6 is an enlarged partial perspective view of the system taken generally along 6-6 in FIG. 1 showing a drying zone; and

FIG. 7 is a simplified flow diagram of a method for cleaning and drying paw areas of a dog at a dog door.

Reference now should be made to the drawings, in which the same reference numbers are used throughout the different figures to designate the same components.

### DETAILED DESCRIPTION OF ILLUSTRATIVE EMBODIMENTS

The terminology used herein is for the purpose of describing particular embodiments only and is not intended to be limiting. As used herein, the singular forms “a”, “an”, and “the” are intended to include the plural forms as well, unless the context clearly indicates otherwise. It should be noted that the terms “a” and “an” herein do not denote a limitation of quantity, but rather denote the presence of at least one of the referenced items. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

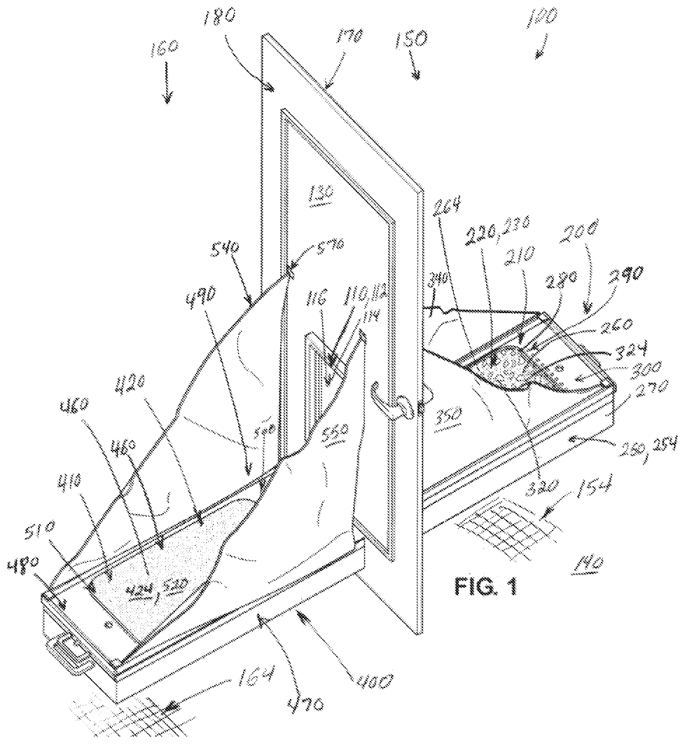

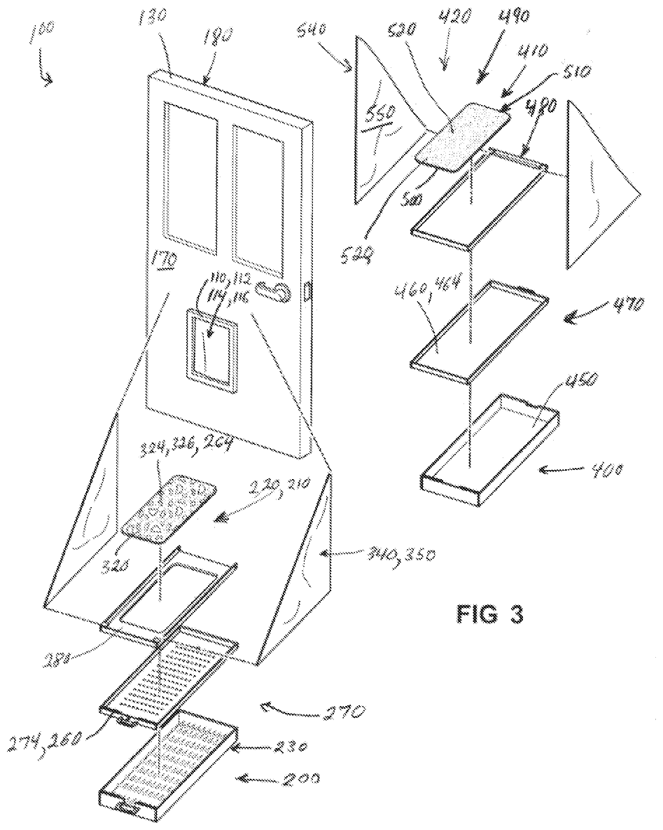

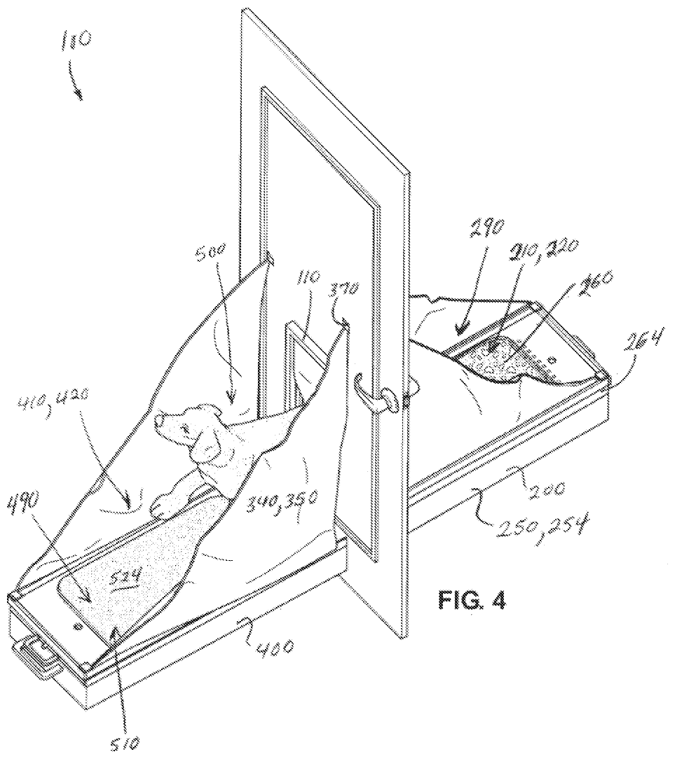

Reference now is made to the drawings, of which FIG. 1 is a simplified partial perspective view of a system 100 for cleaning and drying the paws of a dog (shown in FIG. 4) at a dog door 110 of a residence 140. The dog is shown for purposes of illustration and forms no part of the disclosed subject matter. The dog may have been outdoors and it is desired to avoid or reduce transfer of extraneous materials, such as dirt and mud, to the interior of the residence. The paws are cleaned and dried by functioning of system 100. System 100 is proximate and cooperates with dog door 110 located within a main door 130 of residence 140. Residence 140 has a residence exterior space 150 with an exterior floor 154 and a residence interior space 160 with an interior floor 164. The main door 130 when closed has door exterior surface 170 at the residence exterior space 150 and an opposed door interior surface 180 at the residence interior space 160. Dog door 110 includes a dog door frame 112 affixed to the main door 130 to define an open dog door portal 114 through the main door 130 from the residence exterior space 150 to the residence interior space 160. The dog door 110 has a swinging dog door slab 116 (best shown in FIG. 3) supported in dog door frame 112 to close the open dog door portal 114 when the system 100 is not in use. The dog door slab 116 is supported for movement, such as swinging movement, between a closed position which obstructs or closes the dog door portal 114 and an open position which leaves open the dog door portal 114 for the dog to transit the main door 130 by passing through open dog door portal 114 defined by the dog door frame 112. The dog thus may transit the main door 130 via the dog door 110 between the residence exterior space 150 and residence interior space 160. System 100 is configured to clean the paws to remove extraneous materials from the paws when the dog is located outside the main door 130 and dog door 110. The system 100 is configured to dry the cleaned paws to remove cleaning fluid and extraneous liquid from the clean paws when the dog has passed through dog door 110 into the residence interior space 160.

As shown in FIG. 1, system 100 may include a portable exterior cleaning unit 200 located in the residence exterior space 150. The exterior cleaning unit 200 may include a cleaning unit major body assembly 270. The cleaning unit major body assembly 270 may include cleaning zone structure 210 defining a cleaning zone 220. The cleaning zone structure 210 may include a cleaning unit major upper frame 280 that defines a cleaning zone runway 290 that provides an exterior approach to the dog door 110 from the exterior floor 154. The cleaning zone runway 290 may include an entry area 300 spaced apart from an exit area 310. The cleaning zone runway 290 thus may span from the entry area 300 to exit area 310. The exit area 310 is proximate at least one of the dog door 110 and the door exterior surface 170 of the main door 130 proximate the dog door 110.

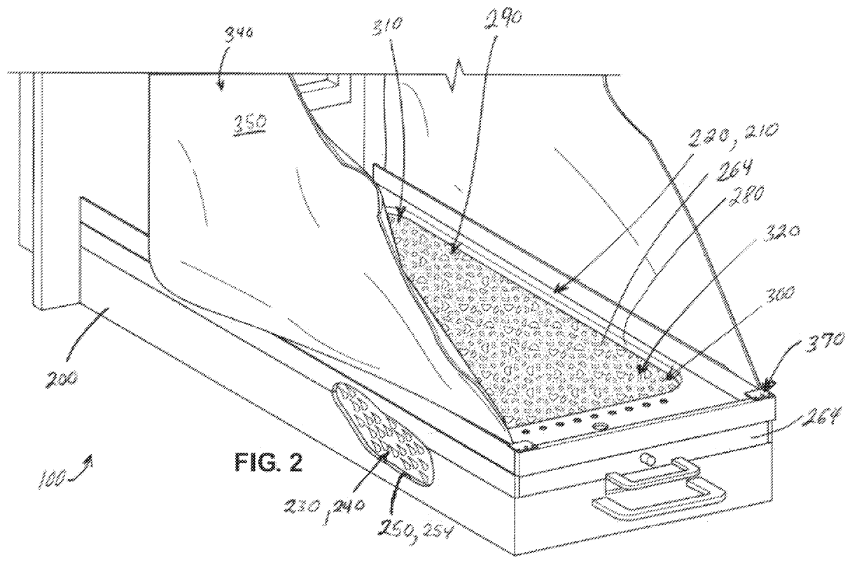

As shown in FIGS. 1-2, the cleaning zone structure 200 may include primary paw receiving structure 320 located in the cleaning zone runway 290. The primary paw receiving structure 320 may be supported in relation to the cleaning unit major upper frame 280. The primary paw receiving structure 320 may be formed of flexible material, such as flexible fabric material, and may be configured to deflect under load towards a secondary paw contacting structure 260 located beneath the primary paw receiving structure 320 to contact cleaning fluid 240 (shown in FIG. 2) above the secondary paw contacting structure 260. The primary paw receiving structure 320 may be configured to return to an undeflected position spaced above the secondary paw contacting structure 260 when unloaded.

The cleaning zone structure 210 may include secondary paw contacting structure 260 located in the cleaning zone runway 290. The secondary paw contacting structure 260 may be configured for cooperation with the primary paw receiving structure 320. The secondary paw contacting structure 260 may be located beneath the primary paw receiving structure 320 to prevent excess deflection of flexible fabric material of the primary paw receiving structure 320. The secondary paw contacting structure 260 may be positioned below a cleaning fluid level in submerged relationship to cleaning fluid (shown in FIG. 2) held in cleaning fluid structure 230.

The cleaning zone structure 210 may include cleaning fluid structure 230 configured to provide cleaning fluid (shown in FIG. 2) to at least one of the primary paw receiving structure 320 and secondary paw contacting structure 260. The cleaning fluid structure 230 may include a cleaning fluid receptacle 250 configured to store cleaning fluid (shown in FIG. 2). In an embodiment. the cleaning zone structure 210 may include a false bottom structure. The cleaning zone runway 290 may include an incline proximate the dog door 110.

System 100 may include a portable exterior tunnel subsystem 340 configured for cooperation with the exterior cleaning unit 200. The exterior tunnel subsystem 340 may include a pair of tunnel sidewalls 350 supported for cooperation with the cleaning zone structure 210. Each of the tunnel sidewalls 350 may span between the cleaning unit major body assembly 270 to the door exterior surface 170 to enclose longitudinal sides of the cleaning zone runway 290. The tunnel sidewalls 350 thus may confine the exterior approach along the cleaning zone runway 290 from the entry area 300 to the exit area 310.

System 100 may include a portable interior drying unit 400 located in the residence interior space 160. The interior drying unit 400 may include a drying unit major body assembly 470. The drying unit major body assembly 470 may include drying zone structure 410 that define a drying zone 420. The drying zone structure 410 may include a drying unit major upper frame 480. The drying unit major upper frame 480 may define a drying zone runway 490. The drying zone runway 490 may provide an interior approach to the interior floor 164 from the dog door 110. The drying zone runway 490 may include an entry area 500 spaced apart from an exit area 510. The drying zone runway 490 may span from the entry area 500 to the exit area 510. The entry area 500 may be proximate at least one of the dog door 110 and the door interior surface 180 of the main door 130 proximate the dog door 110.

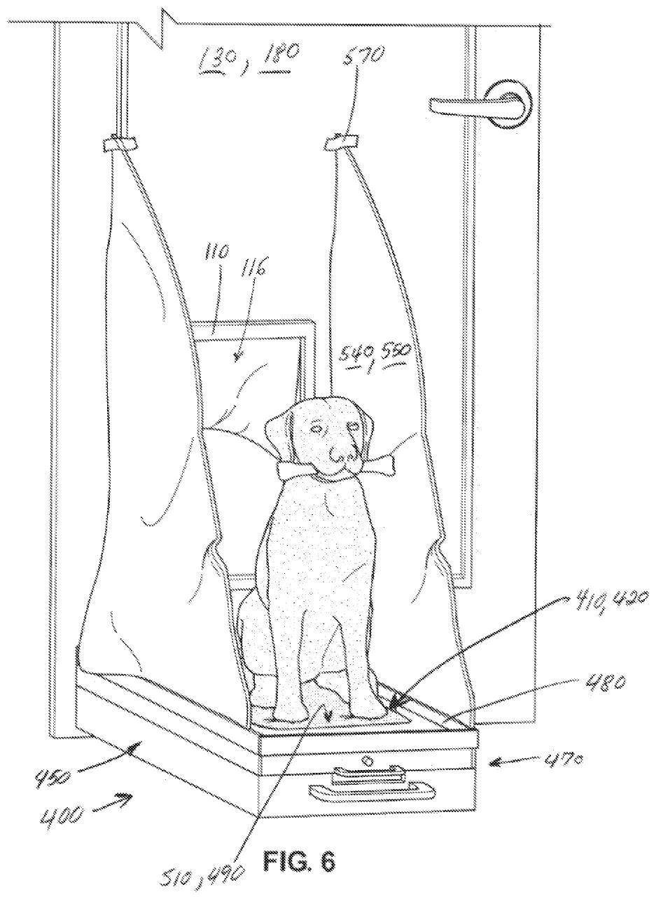

As shown in FIGS. 1, 2, 4 and 6, in system 100 the drying zone structure 410 may include first prime paw receiving structure 520 located in the drying zone runway 490. The first prime paw receiving structure 520 may be supported in relation to the drying unit major upper frame 480. The first prime paw receiving structure 520 may be formed of flexible material and may be configured to deflect under load in the downward direction towards second prime paw contacting structure 460 located beneath the first prime paw receiving structure 520, to contact the second prime paw contacting structure 460. In an embodiment, the first prime paw receiving structure 520 formed of flexible material may be configured to return to an undeflected position spaced above the second prime paw contacting structure 460 when unloaded.

As shown in FIGS. 1, 2, 4 and 6, in system 100 the drying zone structure 410 may include second prime paw contacting structure 460 located in the drying zone runway 490. The second prime paw contacting structure 460 may be configured for cooperation with the first prime paw receiving structure 520. The second prime paw contacting structure 460 may be located beneath the first prime paw receiving structure 520 to prevent excess deflection of flexible material forming first prime paw receiving structure 520. The second prime paw contacting structure 460 may be positioned above a waste collection receptacle 450 located in the drying zone runway 490 beneath the second prime paw contacting structure 460.

As shown in FIGS. 1, 2, 4 and 6, system 100 may include a portable interior tunnel subsystem 540 configured for cooperation with the interior drying unit 400. The interior tunnel subsystem 540 may include a pair of interior tunnel sidewalls 550 supported for cooperation with the drying zone structure 410. Each of the interior tunnel sidewalls 550 may span between the drying unit major body assembly 470 to the door interior surface 180 to enclose longitudinal sides of the drying zone runway 490 and thus confine the interior approach from the entry area 500 to exit area 510.

As shown in FIG. 3, in an embodiment system 100 may include the cleaning fluid structure 230 including a cleaning fluid receptacle 250 defining an open reservoir. In an embodiment, a system 100 may include the cleaning fluid receptacle 250 which is a cleaning fluid tray 254 defining an open reservoir. In an embodiment, system 100 may include the cleaning fluid tray 254 supported in removable relationship to the cleaning unit major upper frame 280. In an embodiment, system 100 may include the secondary paw contacting structure 260 including an intermediate tray 264 having at least one open fluid passage 268 to enable fluid cooperation between cleaning fluid above the submerged secondary paw contacting structure 260 with cleaning fluid held beneath the secondary paw contacting structure 260 in the cleaning fluid tray 254.

As shown in FIGS. 1-3, in an embodiment, system 100 may include at least one of the primary paw receiving structure 320 and secondary paw contacting structure 260 further including a cleaning pad 324 having raised traction nubs. In an embodiment, system 100 may include at least one of the primary paw receiving structure 320 and secondary paw contacting structure 260 further including a cleaning mat 326 having recessed mat structure. In an embodiment, system 100 may include at least one of the primary paw receiving structure 320 and the secondary paw contacting structure 260 further including a cleaning mat 326 formed of at least one of the following: plastic, polyester, foam, rubber, vinyl, and silicone.

As shown in FIGS. 1-3, in an embodiment, system 100 may include the at least one of the first prime paw receiving structure 520 and the second prime paw contacting structure 460 that may include a drying structure 460 formed of flexible moisture-absorbing material 464. In an embodiment, system 100 may include the moisture-absorbing material 464 being selected from at least one of the following: chenille, cotton, flannel, foam, bamboo, microfiber, terrycloth, fleece, or polyester. In an embodiment, system 100 may include the drying structure 460 that further includes a drying pad 524 formed of the moisture-absorbing material 464.

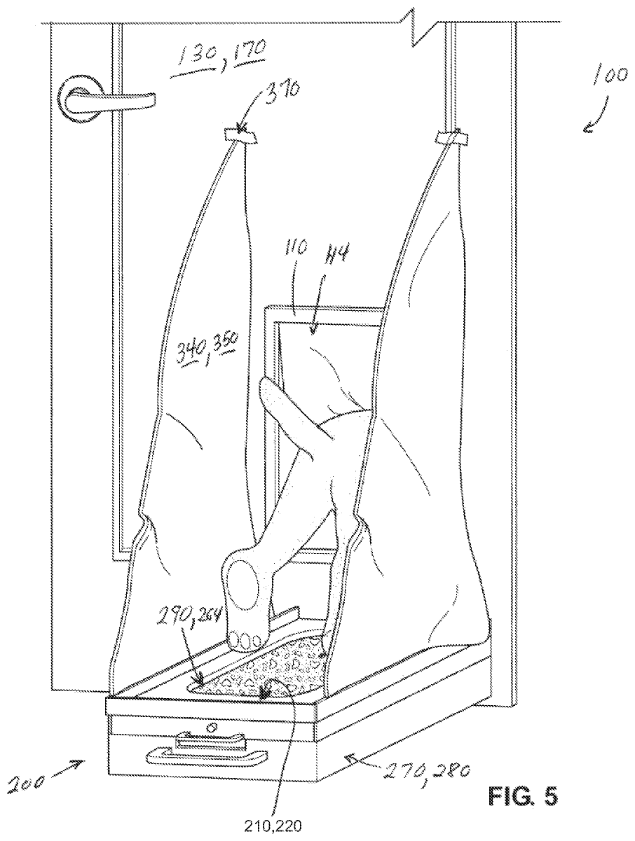

As best shown in FIGS. 1, 4, 5 and 6, in an embodiment, system 100 may include the interior tunnel subsystem 540 and exterior tunnel subsystem 340 further including a selected plurality of releasable fasteners 375 configured to secure each tunnel sidewall 350 in first supported relationship to at least one of the main door 130 and dog door frame 110. It will be understood that, in an embodiment, the interior tunnel subsystem 540 and exterior tunnel subsystem 340 may be supported independent of the main door 130 and dog door frame 110, such as by supported cooperation with, or mounting on, respective of the exterior cleaning unit 200 or interior drying unit 400. In an embodiment, system 100 may include the interior tunnel subsystem 540 and exterior tunnel subsystem 340 each including a selected plurality of releasable fasteners 375, 575 configured to secure each tunnel sidewall 350, 550 in second supported relationship to respective of the exterior cleaning unit 200 and interior cleaning unit 400 in spaced relationship to the dog door 110. In an embodiment, system 100 may include a plurality of releasable fasteners 375, 575 suitable for mounting each of the tunnel sidewalls 350, 550 to supporting structure. Such releasable fasteners 375, 575 in an embodiment may include releasable fastener combinations. In an embodiment, system 100 as disclosed may include a plurality of releasable fastener combinations 375, 575 configured to support the tunnel sidewall panels 350, 550. Such releasable fastener combinations 375, 575 may be selected from the following:
hook combinations,
hook and link combinations,
hook and eyelet combinations,
snap fit combinations,
button and button receiver combinations,
threaded fastener combinations,
nails,
mating hook and loop fastener combinations,
magnetic fastener combinations,
slide and receiver fastener combinations, and
hinged connector combinations.
   Other releasable fasteners may be used.

System 100 thus may include a tunnel subsystem 340, 540 configured to guide the dog through the system 100 within the tunnel subsystem 340, 540 to transit the dog door portal 114 of the dog door 110 between the general exterior space 150 and general interior space 160 of the residence 140. The tunnel subsystem 340, 540 may be formed of a variety of materials in a variety of designs and configurations to fit the needs of the dog which uses the system 100 and residence 140. Exterior tunnel wall panels and interior tunnel wall panels may be fixed to the main door 130 and releasably snap in place and cooperate to form an open tunnel which cooperates with the open dog door portal to enable the dog to transit from the general exterior space to general interior space. This tunnel may be attached through releasable fastener combinations, such as snap fit fastener combinations or hook fastener combinations, to secure the tunnel wall panels to the main door, dog door frame, or both. In an embodiment, the system 100 may include an upright post configured to support each tunnel wall panel proximate the main door or dog door frame. A dog can pass through the system 100 and enter the residence with clean paws.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

Exemplary embodiments of apparatuses, systems, and methods are described and illustrated. Although specific embodiments are illustrated and described herein, it will be appreciated by those of ordinary skill in the art that any arrangement that is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods, and apparatus described herein, one of ordinary skill in the art will appreciate that implementations can be made for other fields of art, systems, apparatus, or methods that provide the required functions.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials. Terminology used in the present disclosure is intended to include all environments and alternate technologies that provide the same functionality described herein.

What is claimed is:

1. A system for cleaning and drying proximate a dog door located in a main door of a residence, the main door having a door exterior surface and opposed door interior surface, the dog door defining an open dog door portal through the main door from the door exterior surface to the door interior surface thereof, said system comprising:
a portable exterior cleaning unit located in the residence exterior space, said exterior cleaning unit including:
a cleaning unit major body assembly including cleaning zone structure defining a cleaning zone, the cleaning zone structure having a cleaning unit major upper frame defining a cleaning zone runway providing an exterior approach to the dog door from an exterior floor, the cleaning zone runway having an entry area spaced apart from an exit area, the cleaning zone runway spanning from said entry area to said exit area, said exit area proximate at least one of the following:
the dog door, and
the exterior surface of the main door proximate the dog door;
said cleaning zone structure comprising flexible primary paw receiving structure located in the cleaning zone runway, the primary paw receiving structure supported in relation to the cleaning unit major upper frame, the primary paw receiving structure configured to deflect under load towards secondary paw contacting structure located beneath the primary paw receiving structure to contact cleaning fluid above the secondary paw contacting structure, the primary paw receiving structure configured to return to an undeflected position spaced above the secondary paw contacting structure when unloaded;
said cleaning zone structure comprising said secondary paw contacting structure located in the cleaning zone runway, the secondary paw contacting structure configured for cooperation with the primary paw receiving structure, the secondary paw contacting structure located beneath the primary paw receiving structure to prevent excess deflection of same, the secondary paw contacting structure positioned below a cleaning fluid level in submerged relationship to cleaning fluid held in a cleaning fluid structure;
said cleaning zone structure comprising said cleaning fluid structure configured to provide cleaning fluid to at least one of the primary paw receiving structure and secondary paw contacting structure, said cleaning fluid structure comprising a cleaning fluid receptacle configured to store cleaning fluid;
a portable exterior tunnel subsystem configured for cooperation with the exterior cleaning unit, the exterior tunnel subsystem including a pair of tunnel sidewalls supported for cooperation with the cleaning zone structure, each of said tunnel sidewalls spanning between the cleaning unit major body assembly to the main door exterior surface to enclose longitudinal sides of the cleaning zone runway to confine the exterior approach from said entry area to said exit area;
a portable interior drying unit located in the residence interior space, said interior drying unit including:
a drying unit major body assembly including drying zone structure defining a drying zone, the drying zone structure having a drying unit major upper frame defining a drying zone runway providing an interior approach to the interior floor from the dog door, the drying zone runway having an entry area spaced apart from an exit area, the drying zone runway spanning from said entry area to said exit area, said entry area proximate at least one of the following:
the dog door, and
the interior surface of the main door proximate the dog door,
said drying zone structure comprising first prime paw receiving structure located in the drying zone runway, the first prime paw receiving structure supported in relation to the drying unit major upper frame, the first prime paw receiving structure configured to deflect under load towards second prime paw contacting structure located beneath the first prime paw receiving structure to contact the second prime paw contacting structure, the first prime paw receiving structure configured to return to an undeflected position spaced above the second prime paw contacting structure when unloaded;
said drying zone structure comprising said second prime paw contacting structure located in the drying zone runway, the second prime paw contacting structure configured for cooperation with the first prime paw receiving structure, the second prime paw contacting structure located beneath the first prime paw receiving structure to prevent excess deflection of same, the second prime paw contacting structure positioned above structure;
waste collection receptacle located in the drying zone runway beneath the second prime paw contacting structure; and
a portable interior tunnel subsystem configured for cooperation with the interior drying unit, the interior tunnel subsystem including a pair of interior tunnel sidewalls supported for cooperation with the drying zone structure, each of said interior tunnel sidewalls spanning between the drying unit major body assembly to the main door interior surface to enclose longitudinal sides of the drying zone runway to confine the interior approach from said entry area to said exit area.

2. A system according to claim 1, further comprising:
said cleaning fluid structure comprising a cleaning fluid receptacle defining an open reservoir.

3. A system according to claim 2, further comprising:
said cleaning fluid receptacle comprising a cleaning fluid tray defining an open reservoir.

4. A system according to claim 3, further comprising:
said cleaning fluid tray supported in removable relationship to said cleaning unit major upper frame.

5. A system according to claim 3, further comprising:
said secondary paw contacting structure comprising an intermediate tray including at least one open fluid passage to enable fluid cooperation between cleaning fluid above the submerged secondary paw contacting structure with cleaning fluid held beneath said secondary paw contacting structure in said cleaning fluid tray.

6. A system according to claim 1, further comprising:
at least one of said primary paw receiving structure and said secondary paw contacting structure including a pad having raised traction nubs.

7. A system according to claim 1, further comprising:
at least one of said primary paw receiving structure and said secondary paw contacting structure including a mat having recessed mat structure.

8. A system according to claim 1, further comprising:
at least one of said primary paw receiving structure and said secondary paw contacting structure including a cleaning mat formed of at least one of the following: plastic, polyester, foam, rubber, vinyl, and silicone.

9. A system according to claim 1, further comprising:
at least one of said first prime paw receiving structure and said second prime paw contacting structure including a drying structure formed of moisture-absorbing material.

10. A system according to claim 9, further comprising:
said moisture-absorbing material selected from at least one of the following: chenille, cotton, flannel, foam, bamboo, microfiber, terrycloth, fleece, or polyester.

11. A system according to claim 9, further comprising:
said drying structure including a drying pad formed of the moisture-absorbing material.

12. A system according to claim 1, further comprising:
the interior tunnel subsystem and exterior tunnel subsystem each including a selected plurality of releasable fasteners configured to secure each tunnel sidewall in first supported relationship to at least one of the main door and dog door frame.

13. A system according to claim 1, further comprising:
the interior tunnel subsystem and exterior tunnel subsystem each including a selected plurality of releasable fasteners configured to secure each tunnel sidewall in second supported relationship to respective of the exterior cleaning unit and interior cleaning unit in spaced relationship to the dog door.

14. A system according to claim 1, further comprising:
each tunnel sidewall comprising a tunnel sidewall panel.

15. A system according to claim 14, further comprising:
said tunnel sidewall panel formed of flexible fabric material.

16. A system according to claim 14, further comprising:
said tunnel sidewall panel formed of rigid material.

17. A system according to claim 12, further comprising:
said plurality of releasable fasteners comprising selected releasable fastener combinations.

18. A system according to claim 17, further comprising:
said releasable fastener combinations selected from the following:
hook combinations,
hook and link combinations,
hook and eyelet combinations,
snap fit combinations,
button and button receiver combinations,
threaded fastener combinations,
nails,
mating hook and loop fastener combinations,
magnetic fastener combinations,
slide and receiver fastener combinations, and
hinged connector combinations.

19. A system according to claim 1, further comprising:
said cleaning zone structure including a false bottom structure.

20. A system according to claim 1, further comprising:
said cleaning zone runway including an incline proximate said dog door portal.
